(19) United States
(12) Patent Application Publication
(10) Pub. No.: US 2019/0261426 A1
(43) Pub. Date: Aug. 22, 2019

(54) METHOD FOR PERFORMING RANDOM ACCESS BY TERMINAL, AND DEVICE SUPPORTING SAME

(71) Applicant: LG ELECTRONICS INC., Seoul (KR)

(72) Inventors: Youngdae LEE, Seoul (KR); Bokyoung BYUN, Seoul (KR); Seungjune YI, Seoul (KR); Sangwon KIM, Seoul (KR)

(73) Assignee: LG ELECTRONICS INC., Seoul (KR)

(21) Appl. No.: 16/346,497

(22) PCT Filed: Oct. 27, 2017
(86) PCT No.: PCT/KR2017/011992

§ 371 Date: Apr. 30, 2019

Related U.S. Application Data
(60) Provisional application No. 62/414,807, filed on Oct. 31, 2016.
(60) Provisional application No. 62/414,808, filed on Oct. 31, 2016.
(60) Provisional application No. 62/420,563, filed on Nov. 11, 2016.

(51) Int. Cl. H04W 74/08; H04W 68/02; H04W 76/27; H04W 48/06

(52) U.S. Cl. CPC H04W 74/0833; H04W 48/06; H04W 76/27; H04W 68/02

(57) ABSTRACT

Provided is a method for performing a random access (RA) procedure by a terminal in an RRC-inactive (RRC_INACTIVE) state, in a wireless communication system. The method comprises the steps of: receiving, from a network, an indicator indicating whether access control can be applied to the terminal; when the indicator indicates that the access control can be applied, performing access control for an application or a service to be performed by the terminal; and performing a random access procedure according to a result of performing of the access control.

### BACKGROUND OF THE INVENTION

### Field of the Invention

The present invention relates to a technique for performing a random access operation by a User Equipment in the NR environment.

### Related Art

In order to meet the demand for wireless data traffic since the 4th generation (4G) communication system came to the market, there are ongoing efforts to develop enhanced 5th generation (5G) communication systems or pre-5G communication systems. For the reasons, the 5G communication system or pre-5G communication system is called the beyond 4G network communication system or post long-term evolution (LTE) system.

In NR standardization conference, basically, an RRC state is defined as RRC_CONNECTED state and RRC_IDLE state, and additionally, RRC_INACTIVE state has been introduced. In order to reduce power consumption, a User Equipment in the RRC_INACTIVE state performs a wireless control procedure in the format which is similar to the RRC_IDLE state. However, in order to minimize the control procedure processed when the User Equipment is shifted to the RRC_CONNECTED state, the User Equipment maintains the connection state between the User Equipment and a network similarly to the RRC_CONNECTED state.

As such, a discussion for the RRC_INACTIVE state has been continued, and particularly, a study has been done for how to control a User Equipment in the RRC_INACTIVE state in an aspect of a network.

### SUMMARY OF THE INVENTION

According to the conventional art, an access control is used for barring or allowing a specific service for a User Equipment shifted from an RRC idle state to an RRC connected state. Meanwhile, since a User Equipment in a lightly connected state may be regarded as an RRC inactive state which is a sub-state of the RRC connected state, an eNB may not limit an access of the User Equipment in the lightly connected state, in principle. However, in order to guarantee a successful access in an emergency situation or a successful access according to priority, the eNB needs to perform the access control for a specific service or an application of the User Equipment in the case that the User Equipment in the RRC inactive state detects uplink data/signaling or is shifted the RRC state to the RRC connected state.

According to an embodiment of the present invention, it is provided a method for method for performing a random access (RA) procedure performed by a User Equipment (UE) in an RRC inactive (RRC_INACTIVE) state in a wireless communication system including receiving an indicator indicating whether an access control is applicable to the UE from a network; performing the access control for a service or application that the UE is intended to perform, when the indicator indicates applicable; and performing the RA procedure according to a result of he access control.

The indicator may be transmitted through at least one of a system information block (SIB), an RRC paging message or a broadcasting message.

The performing the random access procedure may include: performing the RA procedure for the service or application, when the service or application passes through the access control.

The access control may be at least one of an access class barring (ACB), an application specific congestion control for data communication (ACDC) for a specific application, a service specific access control (SSAC) for a specific service and an extended access barring (EAB).

The indicator may indicate whether the access control is applicable in a unit of the service or application.

The indicator may indicate whether the access control is applicable for each category for the service or application.

The service or application that the UE is intended to perform may be at least one of an MO-signaling, an MO-data, an MMTEL-voice, an MMTEL-video and a Circuit Switched Fall Back (CSFB).

According to another embodiment of the present invention, it is provided a User Equipment (UE) for performing a random access (RA) procedure in an RRC inactive (RRC_INACTIVE) state in a wireless communication system including a memory; a transceiver; and a processor for connecting the transceiver, wherein the processor is configured to: receive an indicator indicating whether to apply an access control to the UE from a network; perform the access control for a service or application that the UE is intended to perform, when the indicator is applicable; and perform a random access procedure according to a result of performing the access control.

The indicator may be transmitted through at least one of a system information block (SIB), an RRC paging message or a broadcasting message.

The processor may be configured to perform the random access procedure for the service or application, when the service or application passes through the access control.

The access control may be at least one of an access class barring (ACB), an application specific congestion control for data communication (ACDC) for a specific application, a service specific access control (SSAC) for a specific service and an extended access barring (EAB).

The indicator may indicate whether the access control is applicable in a unit of the service or application.

The indicator may indicate whether the access control is applicable for each category for the service or application.

The indicator may indicate whether the access control is applicable for the service or application according to an RRC state of the UE.

A UE may perform an access control even in the case that the UE is in the RRC inactive state, it is guaranteed a successful access in an emergency situation or a successful access according to priority.

### BRIEF DESCRIPTION OF THE DRAWINGS

FIG. 1 shows LTE system architecture.

FIG. 2 shows a control plane of a radio interface protocol of an LTE system.

FIG. 3 shows a user plane of a radio interface protocol of an LTE system.

FIG. 4 shows a structure of a 5G system.

FIG. 5 is a flowchart for describing a method for performing a random access according to an embodiment of the present invention.

FIG. 6 is a flowchart for describing a method for performing a random access according to another embodiment of the present invention.

FIG. 7 is a flowchart for describing a method for performing a random access according to another embodiment of the present invention.

FIG. 8 is a flowchart for describing a method for performing a random access according to an embodiment of the present invention.

FIG. 9 is a block diagram illustrating a wireless apparatus in which an embodiment of the present invention can be implemented.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802.20, evolved UTRA (E-UTRA), etc. IEEE 802.16m is evolved from IEEE 802.16e, and provides backward compatibility with a system based on the IEEE 802.16e. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE. 5G is an evolution of the LTE-A.

For clarity, the following description will focus on LTE-A. However, technical features of the present invention are not limited thereto.

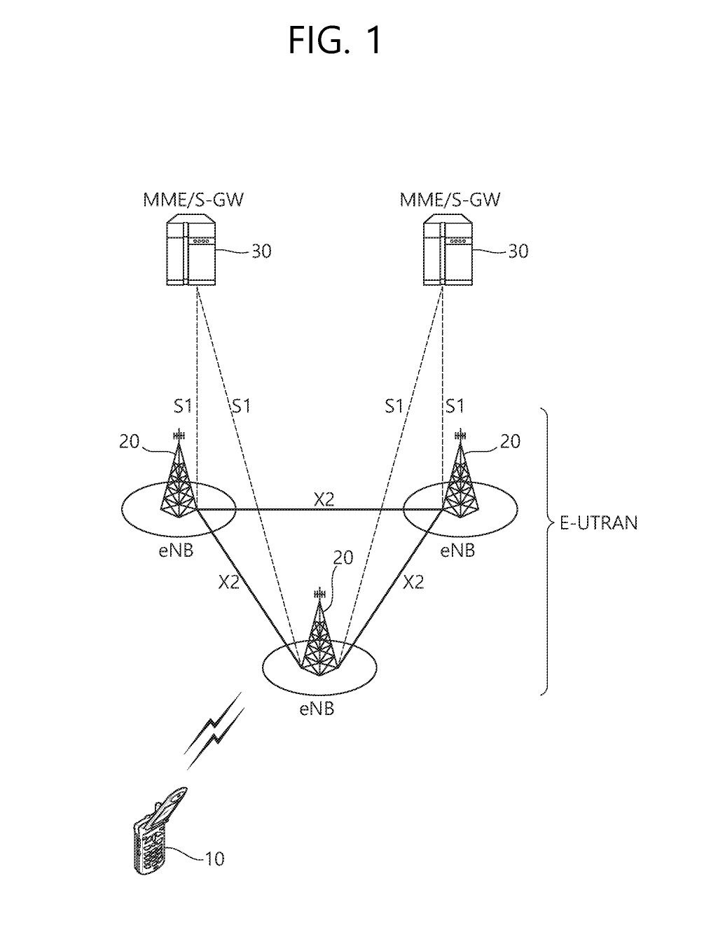

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a serving gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

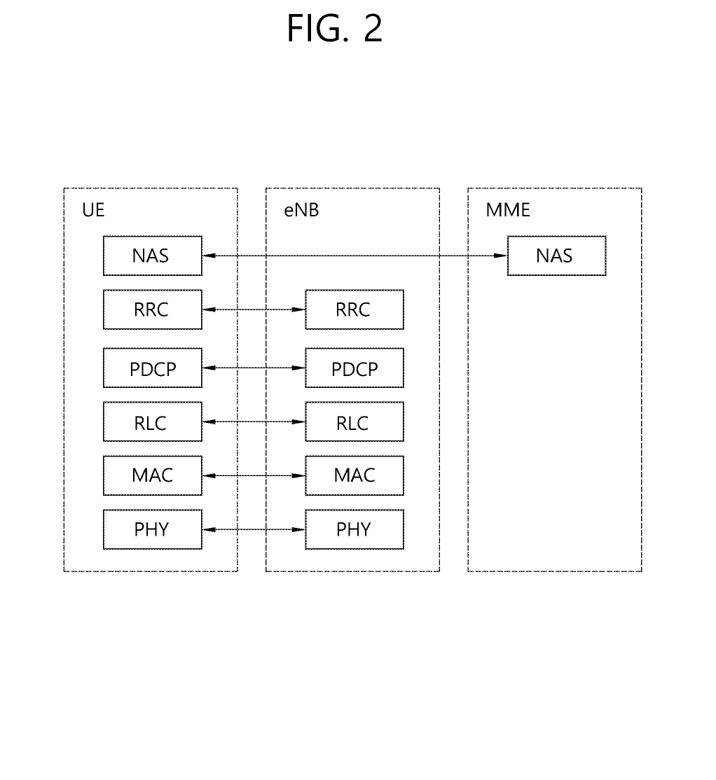

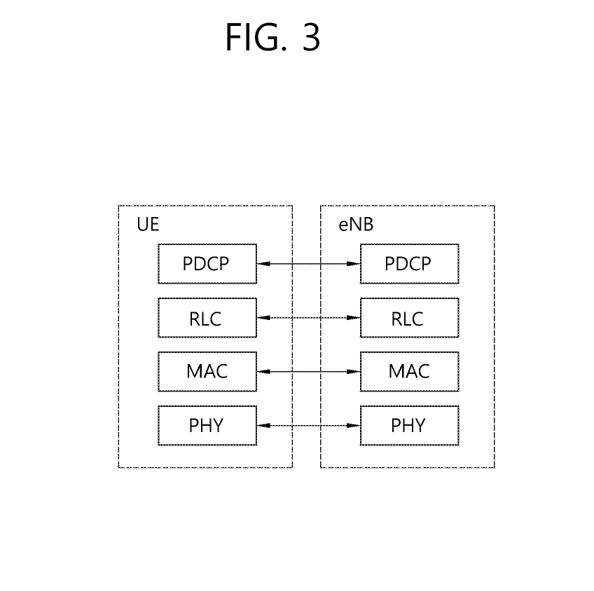

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

A non-access stratum (NAS) layer belongs to an upper layer of the RRC layer and serves to perform session management, mobility management, or the like.

Referring to FIG. 2, the RLC and MAC layers (terminated in the eNB on the network side) may perform functions such as scheduling, automatic repeat request (ARQ), and hybrid automatic repeat request (HARQ). The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

Referring to FIG. 3, the RLC and MAC layers (terminated in the eNB on the network side) may perform the same functions for the control plane. The PDCP layer (terminated in the eNB on the network side) may perform the user plane functions such as header compression, integrity protection, and ciphering.

Hereinafter, RRC State of UE and RRC Connection Method is Described Below.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

In order to manage the mobility of the terminal in the NAS layer positioned on the control planes of the terminal and the MME, an EPS mobility management (EMM) registered state and an EMM deregistered state may be defined. The EMM registered state and the EMM deregistered state may be applied to the terminal and the MME. Like a case of turning on the power of the terminal for the first time, an initial terminal is in the EMM deregistered state and the terminal performs a process of registering the terminal in the corresponding network through an initial attach procedure in order to access the network. When the attach procedure is successfully performed, the terminal and the MME is transitioned to the EMM registered state.

To manage a signaling connection between the UE and the EPC, two states are defined, i.e., an EPS connection management (ECM)-IDLE state and an ECM-CONNECTED state. These two states apply to the UE and the MME. When a UE in the ECM-IDLE state establishes an RRC connection with the E-UTRAN, the UE enters the ECM-CONNECTED state. When an MME in the ECM-IDLE state establishes an S1 connection with the E-UTRAN, the MME enters the ECM-CONNECTED state. When the UE is in the ECM-IDLE state, the E-UTRAN does not have context information of the UE. Therefore, the UE in the ECM-IDLE state performs a UE-based mobility related procedure such as cell selection or reselection without having to receive a command of the network. On the other hand, when the UE is in the ECM-CONNECTED state, a mobility of the UE is managed by the command of the network. If a location of the UE in the ECM-IDLE state becomes different from a location known to the network, the UE announces the location of the UE to the network through a tracking area update procedure.

Hereinafter, a 5G Network Structure is Described.

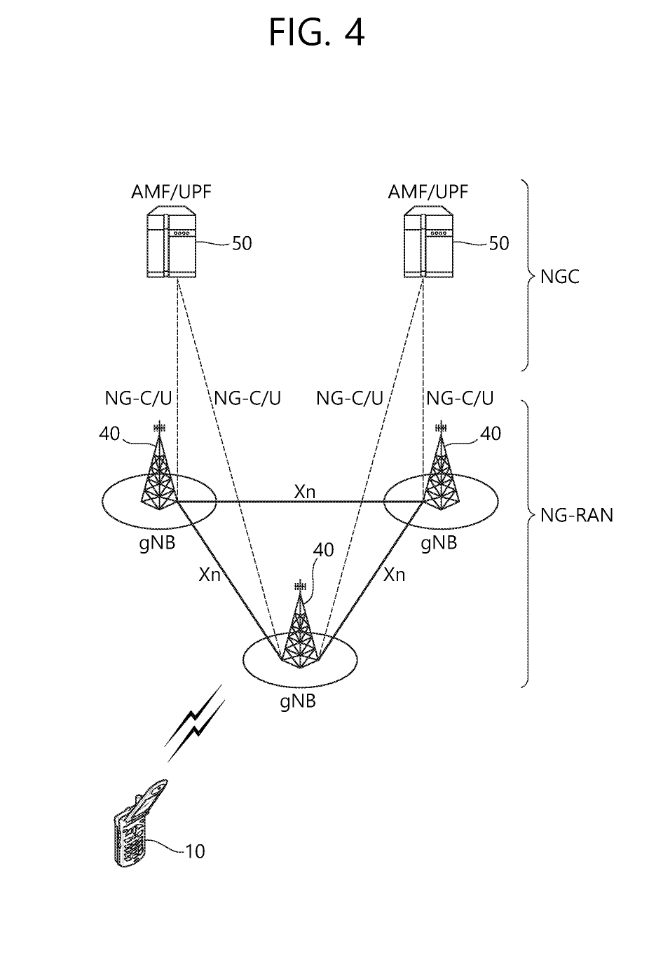

FIG. 4 shows a structure of a 5G system.

In case of an evolved packet core (EPC) having a core network structure of the existing evolved packet system (EPS), a function, a reference point, a protocol, or the like is defined for each entity such as a mobility management entity (MME), a serving gateway (S-GW), a packet data network gateway (P-GW), or the like.

On the other hand, in case of a 5G core network (or a NextGen core network), a function, a reference point, a protocol, or the like is defined for each network function (NF). That is, in the 5G core network, the function, the reference point, the protocol, or the like is not defined for each entity.

Referring to FIG. 4, the 5G system structure includes at least one UE 10, a next generation-radio access network (NG-RAN), and a next generation core (NGC).

The NG-RAN may include at least one gNB 40, and a plurality of UEs may be present in one cell. The gNB 40 provides the UE with end points of the control plane and the user plane. The gNB 40 is generally a fixed station that communicates with the UE 10 and may be referred to as another terminology, such as a base station (BS), a base transceiver system (BTS), an access point, or the like. One gNB 40 may be arranged in every cell. At least one cell may be present in a coverage of the gNB 40.

The NGC may include an access and mobility function (AMF) and a session management function (SMF) which are responsible for a function of a control plane. The AMF may be responsible for a mobility management function, and the SMF may be responsible for a session management function. The NGC may include a user plane function (UPF) which is responsible for a function of a user plane.

Interfaces for transmitting user traffic or control traffic may be used. The UE 10 and the gNB 40 may be connected by means of a Uu interface. The gNBs 40 may be interconnected by means of an X2 interface. Neighboring gNBs 40 may have a meshed network structure based on an Xn interface. The gNBs 40 may be connected to an NGC by means of an NG interface. The gNBs 40 may be connected to an AMF by means of an NGC interface, and may be connected to a UPF by means of an NG-U interface. The NG interface supports a many-to-many-relation between the gNB 40 and the AMF/UPF 50.

A gNB host may perform functions such as functions for radio resource management, IP header compression and encryption of user data stream, selection of an AMF at UE attachment when no routing to an AMF can be determined from the information provided by the UE, routing of user plane data towards UPF(s), scheduling and transmission of paging messages (originated from the AMF), scheduling and transmission of system broadcast information (originated from the AMF or O&M), or measurement and measurement reporting configuration for mobility and scheduling.

An access and mobility function (AMF) host may perform primary functions such as NAS signalling termination, NAS signalling security, AS security control, inter CN node signalling for mobility between 3GPP access networks, idle mode UE reachability (including control and execution of paging retransmission), tracking area list management (for UE in idle and active mode), AMF selection for handovers with AMF change, access authentication, or access authorization including check of roaming rights.

A user plane function (UPF) host may perform primary functions such as anchor point for Intra-/inter-RAT mobility (when applicable), external PDU session point of interconnect to data network, packet routing & forwarding, packet inspection and user plane part of policy rule enforcement, traffic usage reporting, uplink classifier to support routing traffic flows to a data network, branching point to support multi-homed PDU session, QoS handling for user plane, e.g. packet filtering, gating, UL/DL rate enforcement, uplink traffic verification (SDF to QoS flow mapping), transport level packet marking in the uplink and downlink, or downlink packet buffering and downlink data notification triggering.

A session management function (SMF) host may perform primary functions such as session management, UE IP address allocation and management, selection and control of UP function, configuring traffic steering at UPF to route traffic to proper destination, controlling part of policy enforcement and QoS, or downlink data notification.

Hereinafter, an RRC INACTIVE State of a UE is Described.

In the discussion on the NR standardization, an RRC_INACTIVE state (RRC inactive state) has been newly introduced in addition to the existing RRC_CONNETED state and RRC_IDLE state. The RRC_INACTIVE state may be a concept similar to a lightly connected mode which is under discussion in LTE. The RRC_INACTIVE state is a state introduced to efficiently manage a specific UE (for example, mMTC UE). A UE in the RRC_INACTIVE state performs a radio control procedure similarly to a UE in the RRC_IDLE state in order to reduce power consumption. However, the UE in the RRC_INACTIVE state maintains a connection state between the UE and a network similarly to the RRC_CONNECTED state in order to minimize a control procedure required when transitioning to the RRC_CONNECTED state. In the RRC_INACTIVE state, a radio access resource is released, but wired access may be maintained. For example, in the RRC_INACTIVE state, the radio access resource is released, but an NG2 interface between a gNB and am NGC or an S1 interface between an eNB and an EPC may be maintained. In the RRC_INACTIVE state, a core network recognizes that the UE is normally connected to a BS. On the other hand, the BS may not perform connection management for the UE in RRC_INACTIVE state.

Meanwhile, in the E-UTRAN, a UE in the RRC_CONNECTED state is unable to support a UE-based cell reselection procedure. However, a UE in the RRC_INACTIVE state may perform the cell reselection procedure, and in this case, the UE needs to inform position information of the UE with the E-UTRAN.

Hereinafter, Access Class Barring (ACB) is Described.

A service user may obtain a right of preferentially accessing a radio access network by using an ACB mechanism. The ACB mechanism may provide an access priority to a UE on the basis of an allocated access class. In the case that the service user belongs to any one of special access classes, the UE may preferentially access the network in a congested situation in comparison with other UEs.

In the case that the UE is a member of any one access class corresponding to an allowed class and the access class is applicable to a serving network, an access attempt may be allowed. Otherwise, the access attempt is not allowed. In addition, even in the case that a common access is allowed, the serving network may indicate that the UE is limited to perform a location registration. In the case that the UE responds to paging, the UE may follow a generally defined procedure.

A requirement for applying the ACB is as follows.
The serving network broadcasts to the UE a barring rate and a mean duration of access control commonly applied to access classes 0 to 9. This may also be equally applied to access classes 11 to 15.
The network may support an access control on the basis of an access attempt type. The network may combine the access control on the basis of the access attempt type such as mobile originating (MO), mobile terminating, and location registration, and the like. The mean duration of access control and the barring rate may be broadcast for each access attempt type.
The UE determines a barring status on the basis of information provided from the serving network, and performs an access attempt according to the determination. The UE may generate a random value between 0 and 1 when a connection establishment is initialized, and may compare this value with a current barring rate to determine whether the UE is barred. In the case that the random value is less than the barring rate and it is indicated that the access attempt type is allowed, the access attempt may be allowed. Otherwise, the access attempt is not allowed. In the case that the access attempt is not allowed, an additional access attempt conforming to the same type is barred for a specific duration calculated on the basis of the mean duration of access control.

An RRC layer of the UE performs the ACB when an NAS layer of the UE requests an RRC connection, and an RRC connection request message is transmitted to an eNB through a random access procedure only when the ACB is passed through. In order to perform the ACB, the RRC layer of the UE may acquire ACB information through system information which is broadcast from a cell. The ACB information may include different barring times and barring factors with respect to different RRC establishment causes.

When the NAS layer of the UE requests an RRC connection, the eNB reports the RRC establishment cause, and the RRC layer of the UE performs the ACB by using a barring time and a barring factor corresponding to the RRC establishment cause. When the ACB is performed, the RRC layer of the UE generates a random value and compares this value with the barring factor, and whether to perform barring may be determined according to whether the generated random value is greater than or less than the barring factor. When the barring is performed, the UE is unable to transmit the RRC connection request message during the barring time.

Meanwhile, the system information which transmits the ACB information may be an SIB2. The SIB2 includes information required for the UE to access a cell. This includes information for uplink cell bandwidth, a random access parameter, a parameter related to uplink power control, and the like.

Particularly, the SIB2 may include the ACB related information as represented in Table 1 below.

TABLE 1

| Field | Description |
|---|---|
| ac-BarringFactor | When a random value generated by the UE is smaller than a |
| | value of ac-BarringFactor, access is allowed. Otherwise, |
| | the access is barred. |
| ac-BarringForCSFB | ACB for circuit switch (CS) fallback. The CS fallback |
| | converts a VOLTE call to a previous 3G call. |
| ac-BarringForEmergency | ACB for an emergency service. |
| ac-BarringForMO-Data | ACB for Mobile Orienting data. |
| ac-BarringForMO-Signalling | ACB for Mobile Orienting control signal. |
| ac-BarringForSpecialAC | ACB for specific access classes, that is, 11 to 15. |
| ssac-BarringForMMTEL- | ACB for each service for Mobile Orienting of MMTEL |
| Video | video. |
| ssac-BarringForMMTEL- | ACB for each service for Mobile Orienting of MMTEL |
| Voice | voice. |

As described above, the access control is used for barring or allowing a specific service for a UE which is shifting from the RRC idle state to the RRC connected state. Since a UE in the lightly connected state may be regarded as an RRC inactive state which is a sub-state of the RRC connected state, an eNB may not limit an access of the User Equipment in the lightly connected state, in principle. However, in order to guarantee a successful access in an emergency situation or a successful access according to priority, the eNB needs to perform the access control for a specific service or an application of the UE in the case that the UE in the RRC inactive state detects uplink data/signaling or is shifted the RRC state to the RRC connected state.

Hereinafter, a method for performing a random access according to an embodiment of the present invention is described. The access control for the conventional service or application is applied only to a UE in the RRC idle state. According to an embodiment of the present invention, the access control for the service or application is applied even to the UE in the RRC inactive state or the UE in the lightly connected state. In order for the access control for the service or application to be available, the UE in the RRC inactive state may receive system information including an access control related indicator indicating whether the control for the service or application is applicable to the UE from a network. That is, the access control related indicator may indicate whether the UE intended to perform a specific service or application allows the access control or the specific service or application.

In the case that uplink data/signaling for the specific service or application is generated, the UE in the RRC inactive state may enter the RRC connected state. In this case, the UE may determine whether the access control or the specific service or application is applicable based on the access control related indicator which is received from the eNB. In the case that the access control related indicator indicates that the access control or the specific service or application is applicable, the UE may perform an access control mechanism for the service or application before performing a random access procedure. On the other hand, in the case that the access control related indicator indicates that the access control or the specific service or application is not applicable, the UE may perform the random access procedure immediately. The UE may receive the access control related indicator through at least one of a system information message, an RRC paging message or other broadcasting message.

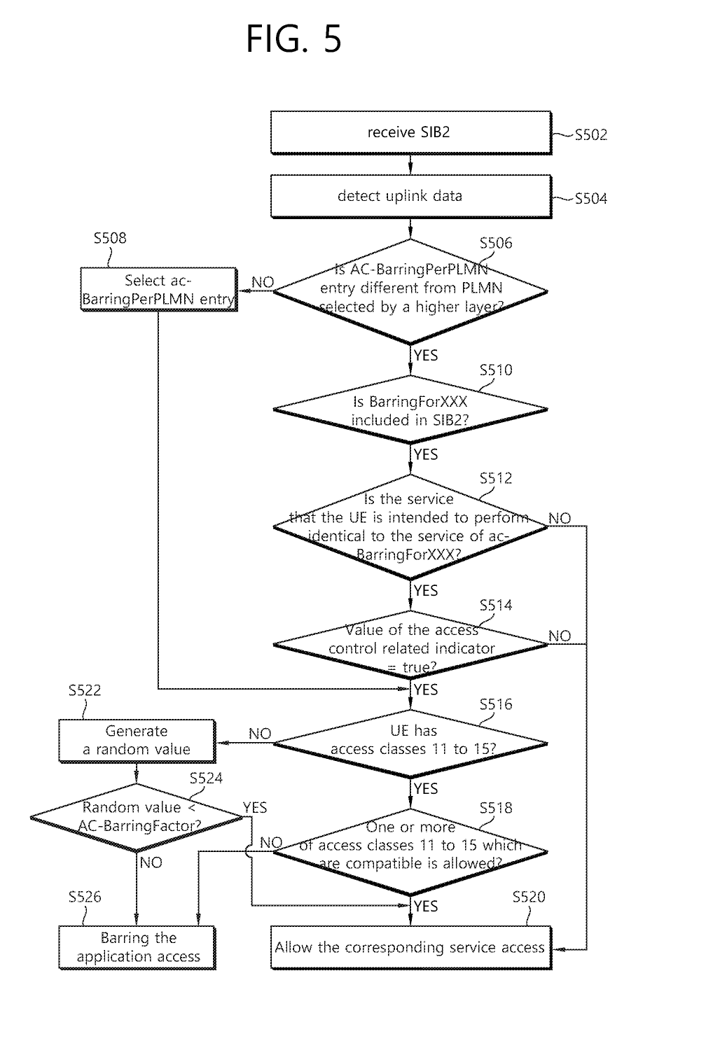

FIG. 5 is a flowchart for describing a method for performing a random access according to an embodiment of the present invention. In this embodiment, it is assumed that an initial UE state is the RRC inactive state.

In step S502, a UE may receive system information. According to an embodiment, the system information may be SIB2, and the SIB2 may include the access control related indicator indicating whether to allow an access control of the UE.

Particularly, the SIB2 may include ac-BarringPerPLMN-List. In addition, the SIB2 may include an access barring related parameter such as ac-BarringForMO-Signalling, ac-BarringForMO-Data, ssac-BarringForMMTEL-Voice, ssac-BarringForMMTEL-Video, ac-BarringForCSFB, and the like. For example, the ac-BarringForMO-Signalling means an access barring related parameter for a service or application called MO-signalling. In addition, the ac-BarringForMO-Data means an access barring related parameter for a service or application called MO-Data. Further, the ssac-BarringForMMTEL-Voice means an access barring related parameter for a service or application called MMTEL-Voice. In addition, ssac-BarringForMMTEL-Video means an access barring related parameter for a service or application called MMTEL-Video. Further, ac-BarringForCSFB means an access barring related parameter for a service or application called Circuit Switched Fall Back (CSFB). As such, the access barring related parameter for a service or application may be represented as ac-BarringForXXX. In the parameter, configuration information (ac-BarringConfig) for the access barring of each access class may be configured. Here, the configuration information may include the access control related indicator indicating whether to allow an access control of the UE.

In step S504, the UE may detect uplink data or signaling. According to this, the UE may initiate an operation for shifting the RRC state from the RRC inactive state to the RRC connected state.

In step S506, the UE determines whether PLMN selected by a higher layer is included in the ac-BarringPerPLMN-List which is included in the received SIB2. Particularly, the UE may determine whether AC-BarringPerPLMN entry matched to plmn-identityIndex corresponding to the PLMN selected by a higher layer is included in the ac-BarringPerPLMN-List.

In step S508, in the case that it is determined that the PLMN selected by a higher layer is included in the ac-BarringPerPLMN-List, the UE may select the AC-BarringPerPLMN entry matched to plmn-identityIndex corresponding to the PLMN selected by a higher layer.

In step S510, in the case that it is determined that the PLMN selected by a higher layer is not included in the ac-BarringPerPLMN-List, the UE may determine whether ac-BarringForXXX is included in the SIB2. As described above, the ac-BarringForXXX means an access barring related parameter for a service or application such as MO-signaling, MO-data, MMTEL-voice, MMTEL-video, CSFB, and the like.

In step S512, in the case that ac-BarringForXXX is included in the SIB2, the UE in the RRC inactive state may determine whether the service or application corresponding to the ac-BarringForXXX is a service or application that the UE is intended to initiate. In the case that the service or application that the UE is intended to initiate is different from the service or application corresponding to the ac-BarringForXXX, the access to the service or application that the UE is intended to initiate may be allowed, immediately (refer to step S520.).

In step S514, in the case that the service or application that the UE is intended to initiate is the same as the service or application corresponding to the ac-BarringForXXX, the UE may determine whether the value of the access control related indicator included in the ac-BarringForXXX is true. In the case that the value of the access control related indicator included in the ac-BarringForXXX is not true, the access to the service or application that the UE is intended to initiate may be allowed (refer to step S520.).

In step S516, in the case that the value of the access control related indicator included in the ac-BarringForXXX is true, the UE may determine whether to have access classes 11 to 15. That is, the UE may initiate the ACB procedure for the service or application.

In step S518, in the case that the UE has access classes 11 to 15, the UE may determine whether one of access classes 11 to 15 which are compatible is allowed. In the case that it is allowed, the access to the service or application that the UE is intended to initiate may be allowed (refer to step S520.). In the case that it is not allowed, the access to the service or application that the UE is intended to initiate is barred (refer to step S526.).

In step S522, in the case that the UE does not have access classes 11 to 15 (refer to step S516.), the UE may generate a random value.

In step S524, the UE may determine whether the generated random value is smaller than the value by the ac-BarringFactor. In the case that the generated random value is smaller than the value by the ac-BarringFactor, the access is allowed (refer to step S520.). Otherwise, the access is barred (refer to step S526.).

According to another embodiment, the SIB2 may include an access control related indicator indicating that BarringPerACDC-Category is applicable. That is, the SIB2 may include an access control related indicator indicating that an access control is applicable to the UE for each category of Application specific Congestion control for Data Communication (ACDC). In the case that an RRC inactive UE receives the SIB2 including the access control related indicator, the UE may identify the category of a service or application for a network access using the ACDC parameter included in the SIB2. In other words, the UE may identify whether the category of a service or application that the UE is intended to perform is a category which is targeted to access barring.

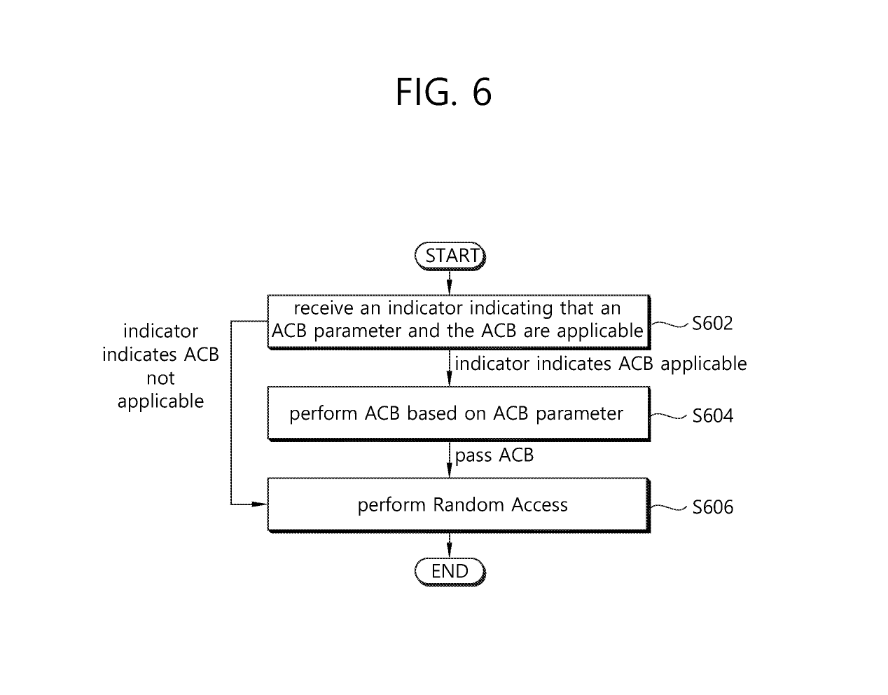

FIG. 6 is a flowchart for describing a method for performing a random access according to another embodiment of the present invention. In this embodiment, the access control related mechanism may be at least one of the access class barring (ACB), the service specific access control (SSAC), the extended access barring (EAB) and the application specific congestion control for data communication (ACDC). In addition, it is regarded that an initial state of a UE is the RRC inactive state.

In step S602, the UE in the RRC inactive state may receive a system information block (e.g., SIB2) including an indicator indicating that an ACB parameter and the ACB are applicable to the UE. The in the RRC inactive state may initiate an RRC state shifting operation to the RRC connected state when uplink data is detected, for example.

In step S604, in the case that the indicator indicates that the ACB is applicable, the UE may perform the ACB by using the ACB parameter which is received through SIB2. Meanwhile, in the case that the indicator indicates that the ACB is not applicable, the UE may progress an RRC state shifting procedure by initiating a random access procedure, not considering the ACB mechanism.

In step S606, in the case that the UE passes through the ACB, the UE may initiate the random access procedure. On the other hand, in the case that the UE is unable to pass through the ACB, the access is barred.

This embodiment is described mainly with the ACB for the convenience of description, but also applicable to the ACDC, the SSAC and the EAB. For example, for the ACDC, in the case that the UE in the RRC inactive state receives the SIB2 including an indicator indicates that the ACDC is applicable to the UE, the UE may apply all ACDC parameters in the SIB2. In addition, for the SSAC, in the case that the UE in the RRC inactive state receives the SIB2 including an indicator indicates that the SSAC is applicable to the UE, the UE may apply all SSAC parameters in the SIB2. Furthermore, for the EAB, in the case that the UE in the RRC inactive state receives the SIB 14 including an indicator indicates that the EAB is applicable to the UE, the UE may apply all EAB parameters in the SIB14.

Meanwhile, in an LTE system, the E-UTRAN controls an access from different services based on a combination of various access control mechanisms, that is, the ACB, the ACB skip, the SSAC, the EAB and the ACDC. The conventional access control mechanism is used for controlling a state shift from the RRC idle state to the RRC connected state mainly. As described above, in NR, a new form of RRC state named the RRC inactive is introduced. When a multiple UEs are intended to shift from the RRC inactive state to the RRC active or the RRC connected state simultaneously, network traffic may occur. Accordingly, in order to guarantee a successful access to a delay-sensitive service such as public safety, it is required an access control mechanism for controlling an uplink access from the RRC inactive state or the RRC idle state.

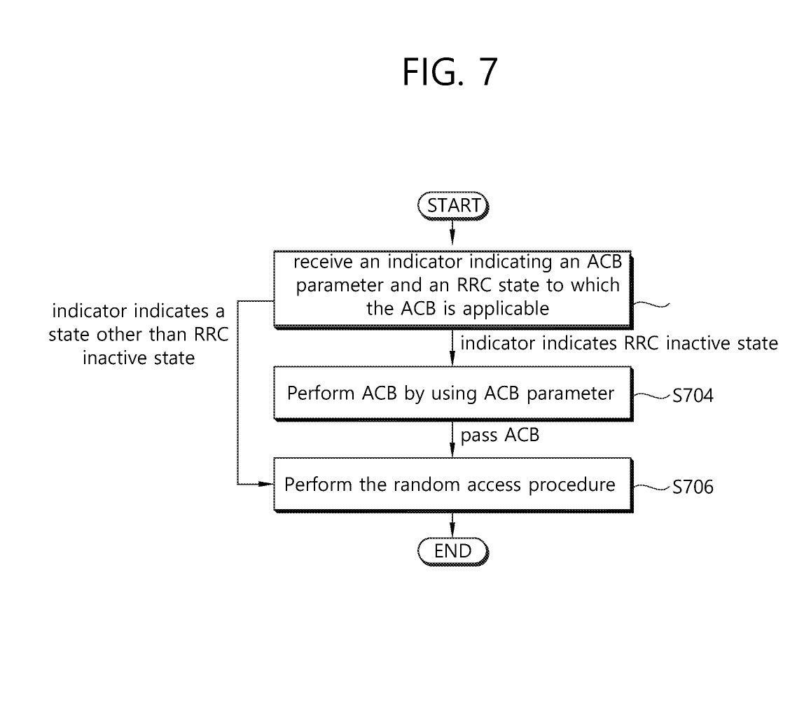

FIG. 7 is a flowchart for describing a method for performing a random access according to another embodiment of the present invention. In this embodiment is designed to apply an access control mechanism to a UE in the RRC inactive state, and a state indicator may be introduced, which indicates an RRC state to which the access control mechanism is applicable (e.g., the RRC idle state, the RRC inactive state and the RRC active state (the RRC connected state).

In the case that the UE initiates a state shift from the RRC idle state or the RRC inactive state to the RRC connected state (the RRC active state), that is, in the case that uplink data/signaling is detected in the UE, the UE may determine whether the access control mechanism is applied to the current RRC state of the UE. According to this embodiment, the UE in a state except the RRC idle state may apply all access control mechanisms which are received through system information based on the state indicator.

For example, in the case that the UE in the RRC inactive state is allowed to transmit data in the RRC inactive state and receives system information including the state indicator indicating the RRC inactive state, the UE performs the access control mechanism before starting the random access procedure. Meanwhile, in the case that the UE in the RRC inactive state is allowed to transmit data in the RRC inactive state and receives system information including the state indicator indicating the RRC state except the RRC inactive state, the UE in the RRC inactive state performs the random access procedure immediately. Here, the state indicator may indicate a combination of two types of RRC states.

In this embodiment, the access control mechanism may be at least one of the access class barring (ACB), the access class barring (ACB) skip, the service specific access control (SSAC), the extended access barring (EAB) and the ACDC, and the UE may receive the state indicator through at least one of a system information message, an RRC paging message or other broadcasting message. However, in FIG. 7, for the convenience of description, the ACB is mainly described.

In step S702, the UE in the RRC inactive state may receive a state indicator indicating a system information block (e.g., SIB2) including an ACB parameter and indicating a state to which the ACB is applicable.

In step S704, in the case that uplink data is forwarded to the UE, the UE in the RRC inactive state initiate an RRC state shift to the RRC connected state (the RRC active state).

In step S706, in the case that the state indicator indicates that the ACB is applicable to the RRC inactive state, the UE in the RRC inactive state performs the ACB by using the ACB parameter which is received from the SIB2. On the other hand, in the case that the state indicator indicates that the ACB is applicable to the RRC idle state, the UE in the RRC inactive state may determine that the ACB is not applicable to the UE in the RRC inactive state. In the case that the UE determines that the ACB is not applicable, the UE initiates the random access procedure, not considering the ACB mechanism, and the UE processes the RRC state shift mechanism.

In step, S708, when the UE passes through the ACB, the UE starts the random access procedure.

As described above, FIG. 7 is described mainly with the ACB, but also applicable to the ACDC, the SSAC and the EAB. For example, for the ACDC, in the case that the UE receives the SIB2 including the state indicator indicates that an RRC state to which the ACDC is applicable to the UE, the UE in the RRC state having the state indicated by the SIB2 needs to apply all ACDC parameters in the SIB2. In addition, for the SSAC, in the case that the UE receives the SIB2 including the state indicator indicates that an RRC state to which the SSAC is applicable to the UE, the UE in the RRC state having the state indicated by the SIB2 needs to apply all SSAC parameters in the SIB2. Furthermore, for the EAB, in the case that the UE receives the SIB 14 including the state indicator indicates that an RRC state to which the EAB is applicable to the UE, the UE in the RRC state having the state indicated by the SIB 14 applies all EAB parameters in the SIB 14.

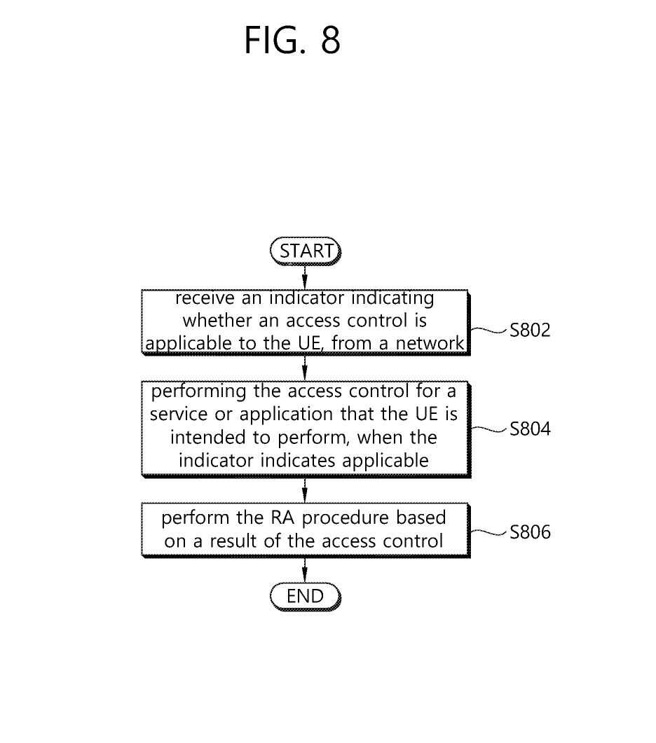

FIG. 8 is a flowchart for describing a method for performing a random access according to an embodiment of the present invention. In this embodiment, it is assumed that an initial UE state is the RRC inactive state.

In step S802, a UE may receive an indicator indicating whether an access control is applicable to the UE. The indicator may be transmitted through at least one of a system information block (SIB), an RRC paging message or a broadcasting message. In addition, the service or application may be at least one of the MO-signaling, the MO-data, the MMTEL-voice, the MMTEL-video and the Circuit Switched Fall Back (CSFB). According to an embodiment, the indicator may indicate whether the access control is applicable in a unit of the service or application. In addition, the indicator may indicate whether the access control is applicable for each category for the service or application. Furthermore, the indicator may indicate whether the access control is applicable for the service or application according to the RRC state of the UE. In addition, the access control may be at least one of the access class barring (ACB), the application specific congestion control for data communication (ACDC) for a specific application, the service specific access control (SSAC) for a specific service and the extended access barring (EAB).

In step S804, in the case that the indicator indicates applicable, the UE may perform the access control for the service or application that the UE is intended to perform.

In step S806, the UE may perform the random access procedure according to the result of the access control. Particularly, as a result of performing the access control, in the case that the service or application passes through the access control, the UE may perform the random access procedure for the service or application.

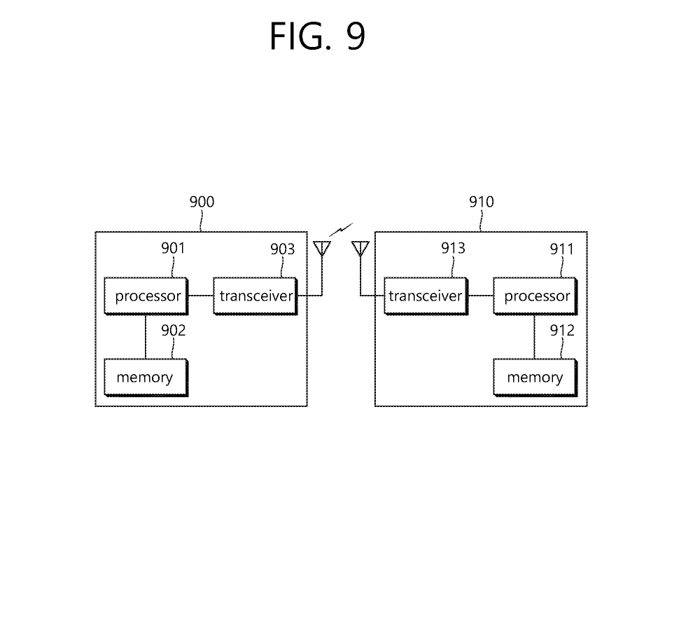

FIG. 9 is a block diagram illustrating a wireless apparatus in which an embodiment of the present invention can be implemented.

A BS 900 includes a processor 901, a memory 902, and a radio frequency (RF) unit 903. The memory 902 is coupled to the processor 901, and stores a variety of information for driving the processor 901. The RF unit 903 is coupled to the processor 901, and transmits and/or receives a radio signal. The processor 901 implements the proposed functions, procedures, and/or methods. In the aforementioned embodiments, an operation of the BS may be implemented by the processor 901.

A UE 910 includes a processor 911, a memory 912, and an RF unit 913. The memory 912 is coupled to the processor 911, and stores a variety of information for driving the processor 911. The RF unit 913 is coupled to the processor 911, and transmits and/or receives a radio signal. The processor 61 implements the proposed functions, procedures, and/or methods. In the aforementioned embodiments, an operation of the UE 910 may be implemented by the processor 911.

The processors 911 may include application-specific integrated circuit (ASIC), other chipset, logic circuit and/or data processing device. The memories may include read-only memory (ROM), random access memory (RAM), flash memory, memory card, storage medium and/or other storage device. The RF units may include baseband circuitry to process radio frequency signals. When the embodiments are implemented in software, the techniques described herein can be implemented with modules (e.g., procedures, functions, and so on) that perform the functions described herein. The modules can be stored in memories and executed by processors. The memories can be implemented within the processors or external to the processors in which case those can be communicatively coupled to the processors via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the scope of the appended claims.

What is claimed is:

1. A method for performing a random access (RA) procedure performed by a User Equipment (UE) in an RRC inactive (RRC_INACTIVE) state in a wireless communication system, the method comprising:
receiving an indicator indicating whether an access control is applicable to the UE, from a network;
performing the access control for a service or application that the UE is intended to perform, when the indicator indicates applicable; and
performing the RA procedure based on a result of the access control.

2. The method of claim 1, wherein the indicator is transmitted through at least one of a system information block (SIB), an RRC paging message or a broadcasting message.

3. The method of claim 1, wherein the performing the RA procedure includes: performing the RA procedure for the service or application, when the service or application passes through the access control.

4. The method of claim 1, wherein the access control is at least one of an access class barring (ACB), an application specific congestion control for data communication (ACDC) for a specific application, a service specific access control (SSAC) for a specific service and an extended access barring (EAB).

5. The method of claim 1, wherein the indicator indicates whether the access control is applicable in a unit of the service or application.

6. The method of claim 1, wherein the indicator indicates whether the access control is applicable for each category for the service or application.

7. The method of claim 1, wherein the indicator indicates whether the access control is applicable for the service or application according to an RRC state of the UE.

8. The method of claim 1, wherein the service or application that the UE is intended to perform is at least one of an MO-signaling, an MO-data, an MMTEL-voice, an MMTEL-video and a Circuit Switched Fall Back (CSFB).

9. A User Equipment (UE) for performing a random access (RA) procedure in an RRC inactive (RRC_INACTIVE) state in a wireless communication system, comprising:
a memory; a transceiver; and a processor for connecting the transceiver, wherein the processor is configured to:
control the transceiver to receive an indicator indicating whether an access control is applicable to the UE, from a network;
perform the access control for a service or application that the UE is intended to perform, when the indicator indicates applicable; and
perform the RA procedure based on a result of the access control.

10. The UE of claim 9, wherein the indicator is transmitted through at least one of a system information block (SIB), an RRC paging message or a broadcasting message.

11. The UE of claim 9, wherein the processor is configured to perform the RA procedure for the service or application, when the service or application passes through the access control.

12. The UE of claim 9, wherein the access control is at least one of an access class barring (ACB), an application specific congestion control for data communication (ACDC) for a specific application, a service specific access control (SSAC) for a specific service and an extended access barring (EAB).

13. The UE of claim 9, wherein the indicator indicates whether the access control is applicable in a unit of the service or application.

14. The UE of claim 9, wherein the indicator indicates whether the access control is applicable for each category for the service or application.

15. The UE of claim 9, wherein the indicator indicates whether the access control is applicable for the service or application according to an RRC state of the UE.
